(19) United States
(12) Patent Application Publication
(10) Pub. No.: US 2002/0026413 A1
(43) Pub. Date: Feb. 28, 2002

(54) Mobile real-time data processing system for use during delivery of products

(75) Inventor: E-Young Wu, Taipei (TW)

Correspondence Address: CHRISTENSEN O'CONNOR, JOHNSON & KINDNESS PLLC, Suite 2800, 1420 Fifth Avenue, Seattle, WA, 98101-2347, US

(73) Assignee: New Global On Line Corp.

(21) Appl. No.: 09/767,661

(22) Filed: Jan. 22, 2001

(30) Foreign Application Priority Data
Aug. 31, 2000 (TW) 089117809

(51) Int. Cl. G06F 17/60

(52) U.S. Cl. 705/39; 705/26

(57) ABSTRACT

A mobile real-time data processing system for use during delivery of a product includes a server and a portable transaction terminal. The server is adapted to establish a connection with a payment control center for conducting non-cash payment. The portable transaction terminal is adapted to be operated by a delivery personnel who is responsible for delivering the product to a customer. By operating the portable transaction terminal, identification data of an electronic money owned by the customer can be inputted, and a communications link can be established with the server for transmitting the identification data to the payment control center so that payment for the product can be arranged by the payment control center through the electronic money of the customer. Upon receiving an approval message sent by the payment control center via the server when the payment control center has successfully completed arrangements for the payment of the product, the portable transaction device generates a printed delivery receipt, and sends delivery confirmation to the server via the communications link when the delivery of the product is completed.

### BACKGROUND OF THE INVENTION

1. Field of the Invention

The invention relates to a data processing system for use during the delivery of products, more particularly to a mobile real-time data processing system for use during the delivery of products.

2. Description of the Related Art

With the growth in popularity of the Internet, more products are now being purchased on-line. Two methods are commonly used for on-line payment of purchased products. The first method, Secure Socket Layer or SSL, is used in almost 99% of on-line purchases. While SSL can prevent unscrupulous parties from having access to customer data during transmission, it cannot prevent stores who have the credit card information of customers from making fraudulent purchases that are charged to the customers' accounts. The second method, Secure Electronic transaction or SET, has a higher security than SSL because it involves a direct connection with the credit card institution, thereby eliminating the need for stores to have the credit card information of customers on hand in order to receive payment. However, because SET requires customers (or card holders) to perform a series of complicated procedures for installing SET-compliant software and for electronic validation, SET inconveniences the customers and is thus not widely used.

Because there are customers who are hesitant to conduct payment on-line, some on-line shops have formed an alliance with couriers, such as postal service providers, who receive cash payment from customers on behalf of the allied shops upon the delivery of purchased products. However, because most customers are generally accustomed to making non-cash payments, such as with the use of credit cards and bank cards, the aforesaid cash payment arrangement will result in inconvenience to customers when the purchased amount is relatively big. Handling of large amounts of cash by delivery personnel will also result in money management and real-time account deposit problems for the couriers. Couriers thus prefer to receive non-cash payment from customers during the delivery of purchased products.

Moreover, delivery personnel usually require customers to sign a delivery receipt upon completing the delivery of purchased products. Confirmation by a sending party (such as an on-line shop) that delivery has been completed is usually possible only after the delivery personnel reports back to the office of the courier. The filing of delivery receipts also creates a burden to couriers.

### SUMMARY OF THE INVENTION

Therefore, the main object of the present invention is to provide a mobile real-time data processing system for use during delivery of products so as to overcome the aforesaid drawbacks of the prior art.

According to the present invention, a mobile real-time data processing system is adapted for use during the delivery of a product, and comprises a server and a portable transaction terminal. The server is adapted to establish a connection with a payment control center for conducting non-cash payment. The portable transaction terminal is adapted to be operated by a delivery personnel who is responsible for delivering the product to a customer, and includes:

means for inputting identification data of an electronic money owned by the customer;

means for establishing a communications link with the server and for transmitting the identification data to the payment control center via the communications link and the server so that payment for the product can be arranged by the payment control center through the electronic money of the customer;

means for receiving an approval message sent by the payment control center via the server and the communications link when the payment control center has successfully completed arrangements for the payment of the product;

means for generating a printed delivery receipt upon receiving the approval message; and

means for sending delivery confirmation to the server via the communications link upon completing the delivery of the product.

### BRIEF DESCRIPTION OF THE DRAWINGS

Other features and advantages of the present invention will become apparent in the following detailed description of the preferred embodiment with reference to the accompanying drawings, of which:

FIG. 1 is a system block diagram of the preferred embodiment of a mobile real-time data processing system according to the present invention;

FIG. 2 is a block diagram of a portable transaction terminal of the preferred embodiment; and

FIG. 3 is a flowchart to illustrate operation of the preferred embodiment.

### DETAILED DESCRIPTION OF THE PREFERRED EMBODIMENT

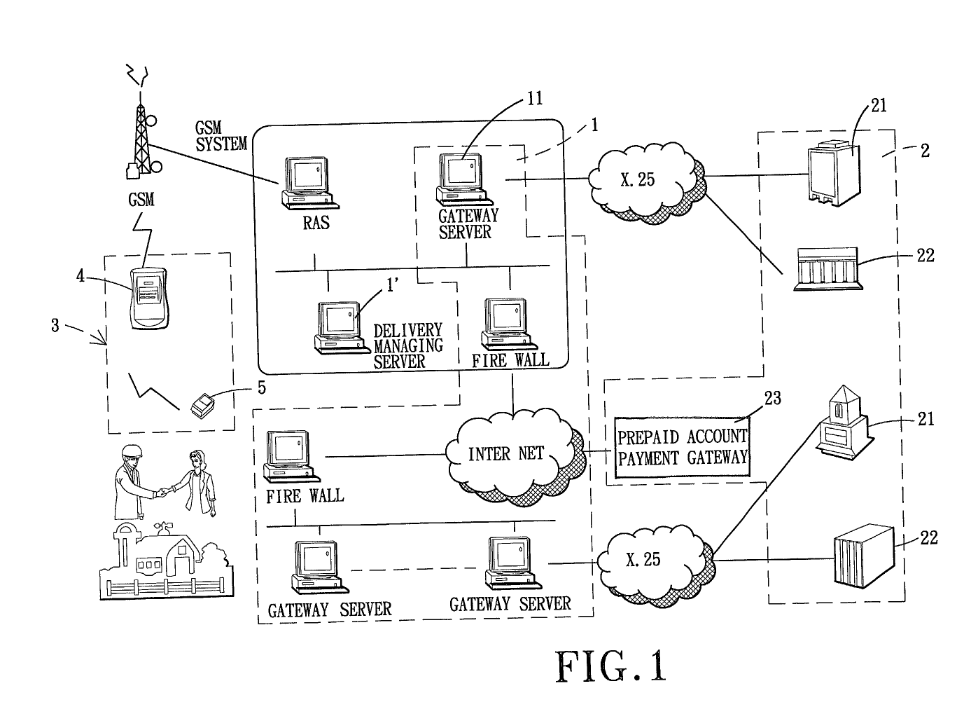

Referring to FIG. 1, the preferred embodiment of a mobile real-time data processing system according to the present invention is shown to comprise a gateway server unit 1 and a portable transaction terminal 3. The gateway server unit 1 is adapted to establish a connection with a payment control center 2 for conducting non-cash payment. The payment control center 2 can be one or more of a credit card institution 21, a banking institution 22 and a prepaid account payment gateway 23. The gateway server unit 1 can connect selectively with the credit card institution 21 to conduct a credit card transaction, with the banking institution 22 to conduct an account transfer transaction, or with the prepaid account payment gateway 23 to conduct a prepaid card transaction.

The gateway server unit 1 is a communications system adapted for connecting two or more networks. The gateway server unit 1 can include a number of gateway servers 11, each having a unique network address. When the portable transaction terminal 3 transmits data for an intended destination (such as a credit card institution 21) via a preset one of the gateway servers 11, the preset gateway server 11 will determine an appropriate data transmission route to the intended destination. Data can thus travel through a number of the gateway servers 11 before reaching the intended destination. The portable transaction terminal 3, which is carried by a delivery personnel who is responsible for delivering a product to a customer, is capable of establishing a communications link with the gateway server unit 1 for data transmission purposes. In the preferred embodiment, the portable transaction terminal 3 is capable of linking to a local area network via a remote access server (or RAS) of a mobile phone system service provider using the short message service (or SMS) protocol of the global system for mobile communication (or GSM system) in order to establish a connection with the preset gateway server 11. Alternatively, the portable transaction terminal 3 can link to the remote access server of an Internet service provider (or ISP) via a public switch telephone network (or PSTN) in order to connect with the preset gateway server 11. Credit card institutions 21 and banking institutions 22 are connected to the gateway server unit 1 using the X.25 communications protocol. Prepaid account payment gateway 23 is connected to the gateway server unit 1 via the Internet. In addition, a delivery managing server 1′ is connected to the remote access server, and is used for storing a product database.

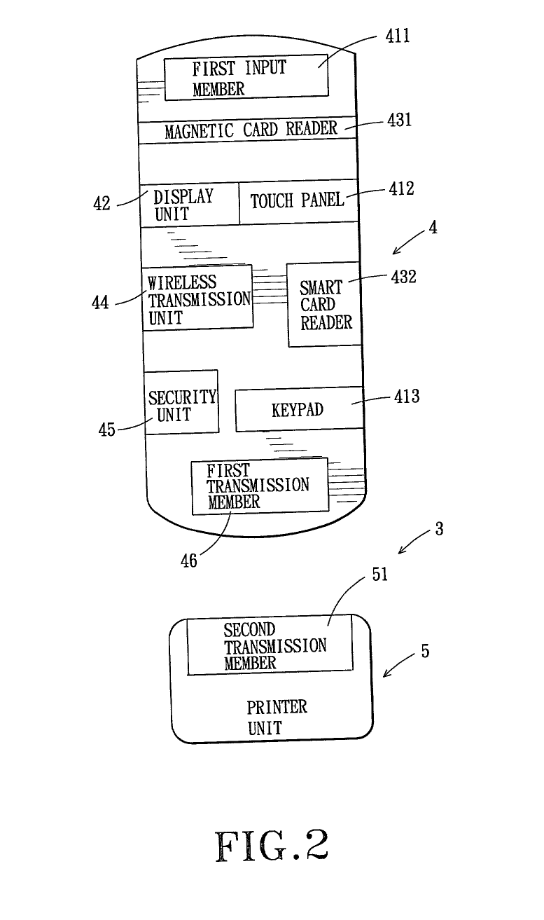

Referring to FIG. 2, the portable transaction terminal 3 includes a portable unit 4 and a printer unit 5. The portable unit 4 includes an input unit, a display unit 42, a card reader, a wireless transmission unit 44 and a first transmission member 46.

The input unit enables the delivery personnel to input product data and customer data (such as credit card number), and can be operated to obtain a signature of the customer. Because products are generally provided with a bar code, the inventory code and price data for a delivered product can be determined by reading the bar code thereof. As such, the input unit of the portable unit 4 includes a first input member 411 for inputting the product data. The first input member 411 can be a bar code reader, such as a laser scanner, adapted for reading the bar code on a delivered product to determine the inventory code and price data of the product. In addition, in order to enable the delivery personnel to select the payment method of the customer, the input unit further includes a second input member. The second input member includes a touch panel 412 that permits the customer to input a signature for confirming receipt of the delivered product or for credit card verification purposes. The second input member can optionally include a keypad 413 that permits the customer to input a password for bank account transaction purposes.

The display unit 42, such as a liquid crystal display or light emitting display, permits the product data read by the input unit to be shown thereon for viewing by both the delivery personnel and the customer. The display unit 42 is also used to show a number of payment methods, such as credit card, bank card, prepaid card, etc., thereon. The desired payment method is selected by the delivery personnel or the customer by operating the touch panel 412.

In order to provide the customer with a number of payment options, the card reader includes a magnetic card reader 431 and a smart card reader 432. When the customer selects the bank card or credit card payment method, the magnetic card reader 431 is used to read identification data stored in a magnetic strip on the bank card or credit card. When the customer selects the prepaid card payment method, the smart card reader 432 is used to read identification data stored in an integrated circuit chip on the prepaid card.

Upon input of the identification data, the wireless transmission unit 44 links to the remote access server of a mobile phone system service provider, and makes a connection to the Internet using a preset account number and password for communicating with the gateway server unit 1 and the delivery managing server 1′ Preferably, the wireless transmission unit 44 is transmission control protocol/Internet protocol (TCP/IP)-compliant so as to be able to communicate with the gateway server unit 1. As such, the wireless transmission unit 44 includes a GSM module for making a dial-up connection with the remote access server, and a local area network (LAN) card for communicating with the gateway server unit 1 using the TCP/IP protocol. As mentioned beforehand, the wireless transmission unit 44 can be replaced by one with an integrated services digital network (ISDN) connection capability for connecting with the gateway server unit 1 and the main unit 1′. Alternatively, the wireless transmission unit 44 can be one with a land-to-satellite wireless transmission capability (such as GPRS).

To enhance security during transmission, the portable unit 4 further includes a security unit 45 for encrypting data, such as product data and electronic money identification data, from the first input member 411 and the card reader in a known manner and for making an electronic signature prior to transmitting the data to the gateway server unit 1 via the wireless transmission unit 44. The gateway server unit 1 decodes the encrypted data prior to transmitting the same to the intended destination, such as the credit card institution 21, the banking institution 22 or the prepaid account payment gateway 23. After the intended destination has successfully completed the necessary arrangements for the payment of the delivered product, an approval message is sent by the intended destination to the portable unit 4 via the gateway server unit 1. The approval message, including the approved transaction amount, is shown on the display unit 42 to allow the customer to verify the payment transaction. Thereafter, the customer uses the touch panel 412 to make a signature, which is sent to the gateway server unit 1 for reference. The customer's signature and the product data are further transmitted to the delivery managing server 1′ for real-time delivery confirmation.

The printer unit 5 is controlled by the portable unit 4 so as to generate a printed delivery receipt for the customer. In order to establish a connection between the printer unit 5 and the portable unit 4, the portable unit 4 further includes the first transmission member 46, whereas the printer unit 5 includes a second transmission member 51 that complements the first transmission member 46. The forms of the first and second transmission members 46, 51 are determined according to the desired transmission mode between the printer and the portable unit 4. The transmission mode can be a wireless transmission mode, such as infrared transmission, blue tooth transmission and frequency modulated (FM) transmission, or a wired transmission mode, such as RS232 or RS485 transmission. In the preferred embodiment, infrared transmission is the chosen mode of transmission between the printer unit and the portable unit 4. As such, the first and second transmission members 46, 51 are configured as infrared transmitter-receiver pairs.

In the preferred embodiment, the touch panel 412 is operated by the customer to make a signature before the delivery receipt is printed. Alternatively, the delivery receipt can be printed for signing by the customer. The signed delivery receipt is then brought back by the delivery personnel for confirmation that the purchased product has been delivered.

When there is no need for the customer to conduct payment for the delivered product, the first input member 411 is used to read the bar code on the delivered product, and the inventory code of the delivered product is shown on the display unit 42 for verification by the customer. The customer then makes a signature with the use of the touch panel 412, and the wireless transmission unit 44 makes a connection with the remote access server so as to send the customer's signature to the delivery managing server 1′ for reference, thereby enabling real-time delivery confirmation. The printer unit 5 is then operated to generate a printed delivery receipt for the customer. In an alternative embodiment, instead of sending the customer's signature to the delivery managing server 1′, the signature can be temporarily stored in the portable unit 4, and will be uploaded to the delivery managing server 1′ when the delivery personnel returns to the office.

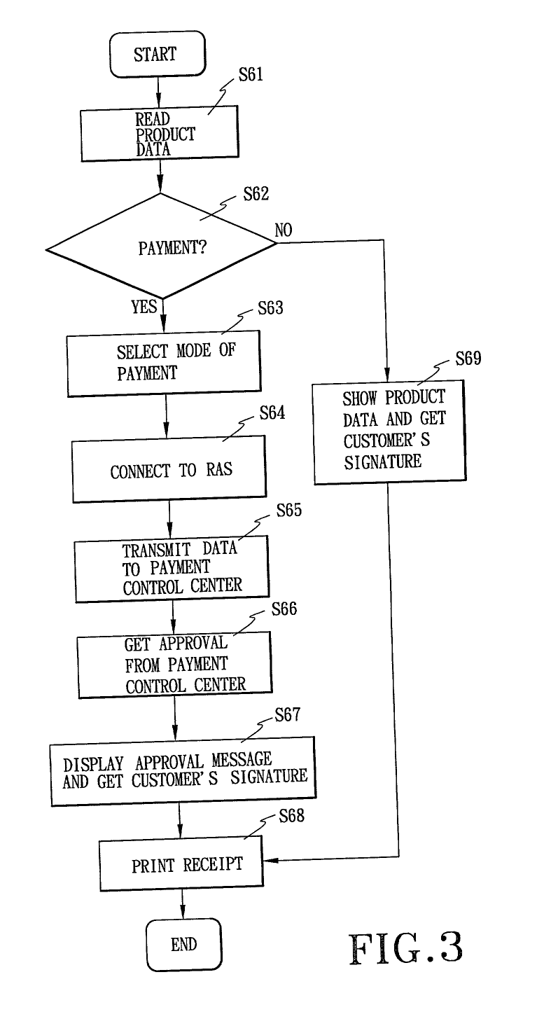

FIG. 3 is a flowchart to illustrate the operation of the system of the preferred embodiment. Initially, instep S61, when a delivery personnel delivers a product to a customer, the first input member 411 of the portable unit 4 is used to read product data, such as inventory code and price data, of the delivered product. The product data is then shown on the display unit 42 for verification by both the delivery personnel and the customer. Then, in step S62, it is determined from the instructions of the sending party whether there is a need to conduct payment upon delivery of the product. If there is a need to conduct payment, the flow proceeds to step S63, where the customer selects a payment mode from among those shown on the display unit 42 with the use of the touch panel 412. The magnetic card reader 431, the smart card reader 432 or the keypad 413 is then operated to input electronic money identification data according to the selected payment mode. In step S64, the wireless transmission unit 44 is used to establish a connection with the remote access server. Subsequently, in step S65, after operation of the security unit 45 for encrypting the product data and the electronic money identification data and for making an electronic signature, the encrypted data and the electronic signature are transmitted to the preset gateway server 11 via the remote access server. After the gateway server 11 decodes the encrypted data and inspects the electronic signature, the gateway server 11 makes a payment approval request to the payment control center 2. In step S66, after the gateway server 11 receives an approval message from the payment control center 2, the gateway server 11 sends the approval message to the portable transaction terminal 3 via the remote access server. In step S67, the approval message is shown on the display unit 42, and the touch panel 412 is subsequently operated to obtain the signature of the customer. The customer's signature is transmitted to the gateway server 11 via the remote access server, and real-time delivery confirmation is sent by the gateway server 11 to the delivery managing server 1′. In step S68, the printer unit 5 is operated to generate a printed delivery receipt to the customer. If it was determined in step S62 that payment is not to be conducted, the flow proceeds to step S69, where the product data is shown on the display unit 42 for verification by both the delivery personnel and the customer, and the signature of the customer is obtained through the use of the touch panel 412. The customer's signature is transmitted to the delivery managing server 1′, and real-time delivery confirmation is sent by the gateway server 11 to the delivery managing server 1′. Thereafter, step S68 is performed so as to issue a printed delivery receipt to the customer with the use of the printer unit 5.

Some of the advantages arising from the use of the system of this invention are as follows:

1. Because electronic money identification data is read by the card reader of the portable transaction terminal 3 under the presence of the customer, and because the data is transmitted directly to the payment control center 2 for conducting non-cash payment, there is no need to provide stores with the identification data to avoid fraudulent use of the same. In addition, because payment is conducted in electronic form, there is no need for customers to have cash on hand during the delivery of products. Furthermore, the printer unit 5 provides the customer with a printed delivery receipt that can also serve as proof of payment.

2. Because the portable transaction terminal 3 can communicate wirelessly with the gateway server unit 1 and the delivery managing server 1′ for data exchange, real-time delivery confirmation is possible. In addition, because the delivery receipt is also available in electronic form, storage and file management of the same are convenient to conduct. Furthermore, to inspect the delivery status of products, it is only necessary to connect with the delivery managing server 1′ to have information on the same.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A mobile real-time data processing system for use during delivery of a product, said system comprising:
a server adapted to establish a connection with a payment control center for conducting non-cash payment; and
a portable transaction terminal adapted to be operated by a delivery personnel who is responsible for delivering the product to a customer, said portable transaction terminal including:
means for inputting identification data of an electronic money owned by the customer;
means for establishing a communications link with said server and for transmitting the identification data to the payment control center via said communications link and said server so that payment for the product can be arranged by the payment control center through the electronic money of the customer;
means for receiving an approval message sent by the payment control center via said server and said communications link when the payment control center has successfully completed arrangements for the payment of the product;
means for generating a printed delivery receipt upon receiving the approval message; and
means for sending delivery confirmation to said server via said communications link upon completing the delivery of the product.

2. The mobile real-time data processing system of claim 1, wherein said server includes:
gateway server means, adapted to connect with the payment control center, for transmitting the identification data from said portable transaction terminal to the payment control center, and for transmitting the approval message from the payment control center to said portable transaction terminal; and
delivery managing server means for receiving the delivery confirmation from said portable transaction terminal.

3. The mobile real-time data processing system of claim 1, wherein:
the payment control center is one of a banking institution, a credit card institution, and a prepaid account payment gateway; and
the electronic money owned by the customer is one of a bank card, a credit card, and a prepaid card.

4. The mobile real-time data processing system of claim 1, wherein said portable transaction terminal further includes means for inputting product data found on the product, means for displaying the product data, and means for sending the product data to said server via said communications link.

5. The mobile real-time data processing system of claim 4, wherein said means for inputting the product data includes a bar code reader.

6. The mobile real-time data processing system of claim 1, wherein said portable transaction terminal further includes means for obtaining a signature of the customer.

7. The mobile real-time data processing system of claim 6, wherein said means for obtaining the signature includes a touch panel.

8. The mobile real-time data processing system of claim 1, wherein said means for inputting the identification data includes a keypad.

9. The mobile real-time data processing system of claim 1, wherein said means for inputting the identification data includes a magnetic card reader.

10. The mobile real-time data processing system of claim 1, wherein said means for inputting the identification data includes a smart card reader.

11. The mobile real-time data processing system of claim 1, wherein said communications link is a wireless communications link.

12. The mobile real-time data processing system of claim 1, wherein said portable transaction terminal further includes means for encrypting the identification data prior to transmission to said server.
